(19) United States
(12) Patent Application Publication
(10) Pub. No.: US 2015/0009253 A1
(43) Pub. Date: Jan. 8, 2015

(54) LIQUID EJECTING APPARATUS AND METHOD OF CONTROLLING LIQUID EJECTING APPARATUS

(71) Applicant: Seiko Epson Corporation, Shinjuku-ku (JP)

(72) Inventor: Hirofumi TERAMAE, Matsumoto-shi (JP)

(21) Appl. No.: 14/321,685

(22) Filed: Jul. 1, 2014

(30) Foreign Application Priority Data
Jul. 2, 2013 (JP) 2013-138661

(51) Int. Cl. B41J 2/045

(52) U.S. Cl. CPC B41J 2/04541
USPC 347/10

(57) ABSTRACT

An ink is ultra-permeation ink which has a surface tension in a range of 25 mN/m or greater and 35 mN/m or less, and a printer is capable of switching between a single-pass mode in which a specific landing pattern is formed on the recording paper by scan performed once and a multi-pass mode in which the specific landing pattern is formed on the landing target by scan performed a plurality of times. A controller performs control such that a total amount of ink which lands on a region in which the specific landing pattern is formed is relatively great in a case of the single-pass mode compared to a case of the multi-pass mode.

### BACKGROUND

1. Technical Field

The present invention relates to a liquid ejecting apparatus, such as an ink jet type recording apparatus, and a method of controlling the liquid ejecting apparatus, and, in particular, to a liquid ejecting apparatus that ejects liquid from nozzles by driving a pressure generator in such a way as to apply a driving waveform included in a driving signal to the pressure generator and by generating pressure fluctuation in liquid within pressure chambers which communicates with the nozzles, and a method of controlling the liquid ejecting apparatus.

2. Related Art

A liquid ejecting apparatus is an apparatus which includes a liquid ejecting head and ejects (discharges) various types of liquid from the liquid ejecting head. The liquid ejecting apparatus includes, for example, an image recording apparatus, such as an ink jet type printer (hereinafter, simply referred to as a printer) or an ink jet type plotter. In recent years, the liquid ejecting apparatus is applied to various types of manufacturing apparatuses with emphasis in a feature in that it is possible to cause a negligible tiny amount of liquid to accurately land on a specific position. The liquid ejecting apparatus is applied to, for example, a display manufacturing apparatus which manufactures the color filters of a liquid crystal display or the like, an electrode forming apparatus which forms electrodes of an organic Electro Luminescence (EL) display, a Field Emission Display (FED), or the like, and a chip manufacturing apparatus which manufactures a biochip (biochemical element). Further, a recording head for the image recording apparatus ejects fluid ink, and a color material ejecting head for the display manufacturing apparatus ejects the solutions of respective color materials of Red (R), Green (G), and Blue (B). In addition, an electrode material ejecting head for the electrode forming apparatus ejects fluid electrode materials, and a bio organic matter ejecting head for the chip manufacturing apparatus ejects the solution of a bio organic matter.

The above-described printer includes an ink jet type recording head (hereinafter, simply referred to as a recording head) which is one kind of the liquid ejecting head, and records (prints) images or characters on a recording medium by performing scan which relatively moves on a recording medium, such as a recording paper, and ejecting ink from the nozzles of the recording head. That is, a pixel, which is configuration units of an image or the like, is formed by one or more dots which are formed in such a way that ink lands on the recording medium, and a pattern (dot pattern) of the image or the like is formed by aligning pixels. As such a kind of printer, there is a printer which can select two types of recording modes including a single-pass recording mode in which the pattern of an image or the like is completed by scan of the recording head performed one time and a multi-pass recording mode in which the pattern of the image or the like is completed by scan of the recording head performed a plurality of times when a specific image or the like is recorded (for example, refer to JP-A-2012-106394).

However, it is possible to exemplify pigment ink or dye ink as a representative of ink which is used to record an image. General pigment ink is excellent in water resistance and weathering resistance after an image or the like is recorded, compared to the dye ink. In addition, since the pigment ink hardly penetrates (hardly permeates) on a recording medium, such as plain paper, the pigment ink is suitable for recording a pattern in which the contour of a letter or a diagram is particularly clear. However, in a so-called solid printing in which the pigment ink is ejected and a specific area is filled with landing ink without gaps, it is necessary to eject a large amount of ink compared to a printing in a case in which the dye ink is used. Here, the “plain paper” means recording paper which is generally sold in a market, and, specifically, it means the paper which is used for electrostatic copying.

As the pigment ink which is suitable for recording an image or the like on the plain paper, ink which is called ultra-permeation ink having high permeation is proposed (for example, refer to JP-A-2000-289193). The ultra-permeation ink has high permeation compared to general pigment ink, with the result that it is possible to form even larger dots using a small amount of ink, and thus wide range can be filled with ink. Therefore, it is possible to apply the ink having high permeation in a so-called solid printing.

However, when images are recorded using the ultra-permeation ink, there is a problem in that the concentrations of the images are different from each other in a case in which recording is performed with signal-pass and a case in which recording is performed with multi-pass even though the same images are recorded. More specifically, the concentration of the image in the case in which recording is performed with the single-pass is thinner than the concentration of the image in the case in which recording is performed with the multi-pass. That is, when recording is performed with the single-pass, more ink lands on the recording paper at a time (per unit time) compared to the case in which recording is performed with the multi-pass, and thus ink does not dry easily. Therefore, it is conceivable that the concentration of the pigment on the surface of the recording paper decreases because the pigment permeates into the recording paper during an interval until the ink dries.

### SUMMARY

An advantage of some aspects of the invention is to provide a liquid ejecting apparatus which is capable of making the concentrations of landing patterns uniform regardless of the number of scans performed when the landing patterns are formed in a configuration in which a so-called ultra-permeation liquid is ejected, and a method of controlling the liquid ejecting apparatus.

According to an aspect of the invention, there is provided a liquid ejecting apparatus including: a liquid ejecting head that includes a plurality of nozzles, ejects a liquid from the nozzles toward an landing target when a pressure generator is driven, and forms an landing pattern by causing the liquid to land on the landing target; a scan section that performs scan by relatively moving the liquid ejecting head with regard to the landing target; and a controller that controls ejection of the liquid of the liquid ejecting head. The liquid is a ultra-permeation liquid which has a surface tension in a range of 25 mN/m or greater and 35 mN/m or less, the liquid ejecting apparatus is capable of switching between a first mode in which a specific landing pattern is formed on the landing target by scan performed once and a second mode in which the specific landing pattern is formed on the landing target by scan performed a plurality of times, and the controller performs control such that a total amount of liquid which lands on a region in which the specific landing pattern is formed is relatively great in a case of the first mode compared to a case of the second mode.

In the liquid ejecting apparatus according to the aspect, control is performed such that a total amount of the liquid which lands on the region in which the specific landing pattern is formed is relatively larger in the case of the first mode compared to the case of the second mode. Therefore, when a specific landing pattern is formed in the first mode, the amount of solid component which remains on the surface of the landing target after the landing liquid is dry is made uniform to the same degree as in the case in which the same landing patterns are formed in the second mode even though solid components which are included in the liquid permeate inside the landing target during a period until the landing liquid dries. Therefore, it is possible to make the concentrations of the landing patterns uniform regardless of the number of scans when the landing pattern is formed.

In the liquid ejecting apparatus, the controller may adjust the total amount of liquid which lands on the region in which the specific landing pattern is formed by relatively changing a driving voltage of a driving waveform, which drives the pressure generator in the first mode, with regard to a driving voltage of a driving waveform which drives the pressure generator in the second mode.

In the liquid ejecting apparatus, the controller may adjust the total amount of liquid which lands on the region in which the specific landing pattern is formed by relatively changing a reference potential of a driving waveform, which drives the pressure generator in the first mode, with regard to a reference potential of a driving waveform which drives the pressure generator in the second mode.

In addition, in the liquid ejecting apparatus, the controller may adjust the total amount of liquid which lands on the region in which the specific landing pattern is formed by relatively changing a droplet landing ratio for the region, in which the specific landing pattern is formed in the first mode, with regard to a droplet landing ratio for a region in which the specific landing pattern is formed in the second mode.

In addition, according to another aspect of the invention, there is provided a method of controlling a liquid ejecting apparatus which includes a liquid ejecting head that includes a plurality of nozzles, ejects a liquid from the nozzles toward an landing target when a pressure generator is driven, and forms an landing pattern by causing the liquid to land on the landing target, a scan section that performs scan by relatively moving the liquid ejecting head with regard to the landing target, and a controller that controls ejection of the liquid of the liquid ejecting head, the liquid being a ultra-permeation liquid which has a surface tension in a range of 25 mN/m or greater and 35 mN/m or less, and the liquid ejecting apparatus being capable of switching between a first mode in which a specific landing pattern is formed on the landing target by scan performed once and a second mode in which the specific landing pattern is formed on the landing target by scan performed a plurality of times, the method including: performing control such that a total amount of liquid which lands on a region in which the specific landing pattern is formed is relatively greater in a case of the first mode compared to a case of the second mode.

### BRIEF DESCRIPTION OF THE DRAWINGS

The invention will be described with reference to the accompanying drawings, wherein like numbers reference like elements.

FIG. 1 is a perspective view illustrating the internal configuration of a printer.

FIG. 2 is a cross-sectional view illustrating the main parts of the configuration of a recording head.

FIG. 3 is a block diagram illustrating the electrical configuration of the recording head.

FIG. 4 is a waveform chart illustrating the configuration of a driving signal.

FIGS. 5A to 5C are schematic diagrams illustrating image recording in each recording mode.

FIG. 6 is a diagram illustrating examples of image patterns which are recorded with regard to a recording paper.

FIG. 7 is a waveform chart illustrating the correction of an ejection driving pulse DP.

FIG. 8 is a waveform chart illustrating another example of the correction of the ejection driving pulse DP.

FIG. 9 is a waveform chart illustrating the correction of the ejection driving pulse DP according to another embodiment.

### DESCRIPTION OF EXEMPLARY EMBODIMENTS

Hereinafter, embodiments of the invention will be described with reference to the accompanying drawings. Meanwhile, in the embodiment which will be described below, various limitations are made as detailed preferable examples of the invention. However, the scope of the invention is not limited to such aspects unless a gist which particularly limits the invention is described in the description below. In addition, hereinafter, an ink jet type recording apparatus (hereinafter, printer) will be described as an example of a liquid ejecting apparatus of the invention.

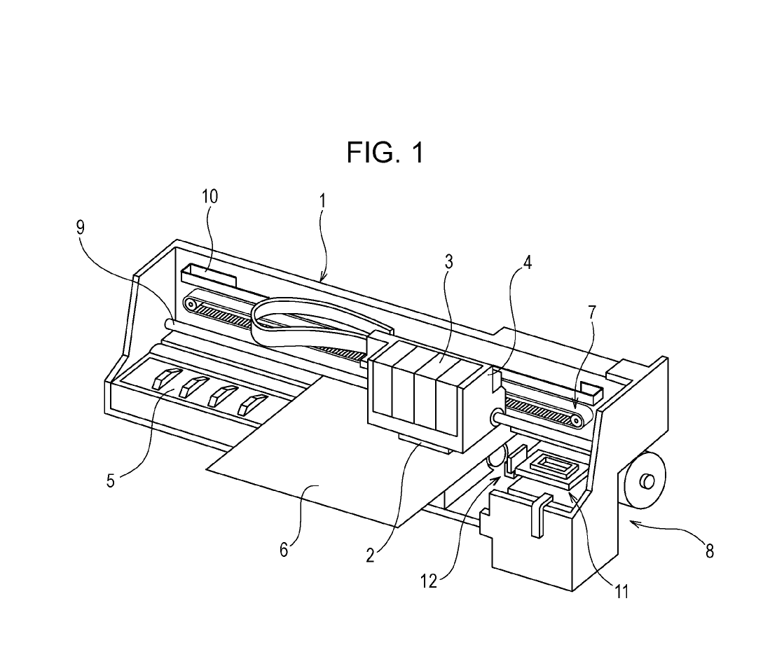

FIG. 1 is a perspective view illustrating the configuration of a printer 1. The illustrated printer 1 ejects ink, which is one kind of liquid, from a recording head 2, which is one kind of a liquid ejecting head, toward a recording medium (liquid landing target), such as recording paper 6 or cloth, which has liquid permeation. According to the embodiment, a so-called ultra-permeation ink, in which permeation with regard to recording paper is improved compared to ink according to the related art, is used as ink. A penetrating agent is added to the ultra-permeation ink in addition to colorant (corresponding to solid component), such as a pigment, and water. The degree of permeation with regard to the recording paper 6 is expressed using surface tension. More specifically, the upper limit of the surface tension is approximately 35 mN/m, more preferably, 33 mN/m, and the lower limit thereof is approximately 25 mN/m, more preferably, 28 mN/m. In addition, a contact angle of the ultra-permeation ink with regard to the recording paper 6 is less than 90°. In addition, in the embodiment, 1,2-hexanediol or glycol ether is included as the penetrating agent in ink. For example, various types of surfactants, such a cationic surfactant, an anionic surfactant, a nonionic surfactant, and an ampholytic surfactant, alcohols, such as methanol, ethanol, and iso-propyl alcohol, and polyalcohol lower alkyl ether, such as ethylene glycol monoethyl ether, diethylene glycol monoethyl ether, diethylene glycol monobutyl ether, triethylene glycol monobutyl ether, propylene glycol monobutyl ether, and dipropylene glycol monobutyl ether, are exemplified as other penetrating agents.

The printer 1 is schematically configured to include a carriage 4 in which a recording head 2 is attached and an ink cartridge 3 that is one kind of a liquid supply source is detachably attached, a platen 5 which is arranged on the lower side of the recording head 2 when a recording operation is performed, a carriage movement mechanism 7 (one kind of a scan section according to the invention) which moves the carriage 4 in the paper width direction of the recording paper 6, that is, causes the carriage 4 to reciprocate in a main scan direction, and a paper feed mechanism 8 which transports the recording paper 6 in a sub-scan direction perpendicular to the main scan direction.

The carriage 4 is attached in a state in which the carriage 4 is pivotally supported by a guide rod 9 constructed in the main scan direction and is configured to move in the main scan direction along the guide rod 9 by the operation of the carriage movement mechanism 7. The position of the carriage 4 in the main scan direction is detected by an linear encoder 10, and a detection signal thereof, that is, an encoder pulse (one kind of positional information) is transmitted to a control unit 30 of a printer controller 28 (refer to FIG. 4). The linear encoder 10 is one kind of a positional information output section, and outputs the encoder pulse based on the scan position of the recording head 2 as positional information in the main scan direction. Therefore, it is possible for the control unit 30 (corresponding to a controller) to recognize the scan position of the recording head 2 which is mounted on the carriage 4 based on the received encoder pulse. That is, it is possible to recognize the position of the carriage 4 by, for example, counting the received encoder pulse. Therefore, it is possible for the control unit 30 to control a recording operation performed by the recording head 2 while recognizing the scan position of the carriage 4 (recording head 2) based on the encoder pulse from the linear encoder 10.

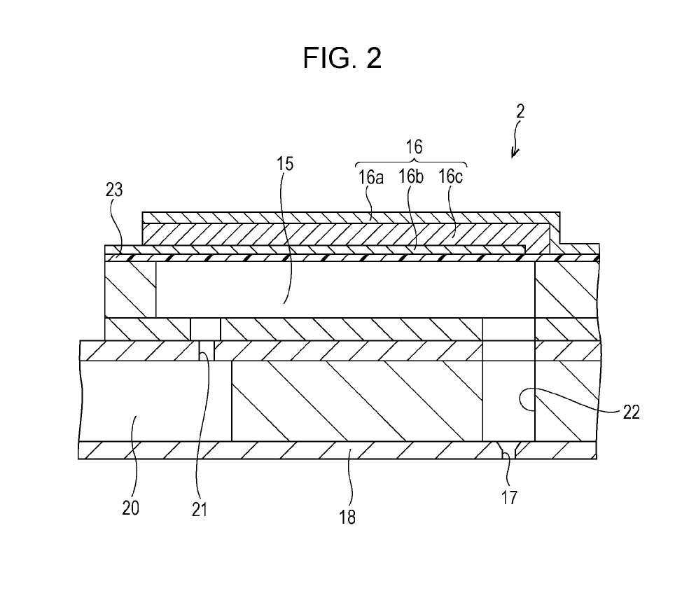

In an end area of the movement range of the carriage 4, which is on the outer side compared to the platen 5, a home position which is the reference of the scan of the carriage is set. The home position according to the embodiment is disposed with a capping member 11 which seals a nozzle formation surface (nozzle plate 18: refer to FIG. 2) of the recording head 2, and a wiper member 12 which sweeps the nozzle formation surface. Further, the printer 1 is configured to be capable of recording an landing pattern, such as a letter or an image, on the recording paper 6 in both directions in a case of forward movement that the carriage 4 moves toward an end which is on an opposite side from the home position and in a case of backward movement that the carriage 4 returns to the side of the home position from the end which is on the opposite side.

FIG. 2 is a cross-sectional view illustrating the main parts of the recording head 2. As shown in the drawing, the recording head 2 is configured in such a way that a plurality of substrates are laminated, and includes an ink flow channel (one kind of a liquid flow channel) through which ink is introduced, a piezoelectric element 16 as a pressure generator which causes pressure fluctuation to occur in ink in pressure chambers 15 included in a portion of the ink flow channel. A nozzle plate 18, in which a plurality of nozzles 17 are consecutively installed, is arranged at the lower portion of the recording head 2 (surface on the side of the recording medium when the recording operation is performed). In the nozzle plate 18, the plurality of (for example, 360) nozzles 17 are provided in parallel in a direction corresponding to the transport direction of the recording paper 6, and thus a nozzle row 23 (corresponding to a nozzle group) is configured. The nozzle row 23 is provided, for example, for each color of ink.

The ink flow channel inside of the recording head 2 is configured to include a reservoir 20 to which ink is introduced from the side of the ink cartridge 3, ink supply openings 21 which cause the reservoir 20 to communicate with the pressure chambers 15, the pressure chambers 15, nozzle communication openings 22 which cause the pressure chamber 15 to communicate with the nozzles 17, and the nozzles 17. The reservoir 20 is an empty portion which is common to the plurality of pressure chambers 15, and is provided for each kind (color) of ink. The pressure chambers 15 are empty portions which are provided for the respective nozzles 17, and include upper openings which are sealed by an elastic film 23 on the opposite side of the nozzle plate. A piezoelectric element 16 corresponding to each of the pressure chambers 15 is arranged on the elastic film 23. The illustrated piezoelectric element 16 is a piezoelectric element in a so-called deflection oscillation mode, and is configured in such a way that a piezoelectric substance 16c is interposed between a drive electrode 16a and a common electrode 16b.

Further, when a driving signal COM is supplied between the drive electrode 16a and the common electrode 16b of the piezoelectric element 16, an electric field is generated based on the phase difference between both the electrodes 16a and 16b. Further, the piezoelectric substance 16c is deformed based on the strength of the given electric field. That is, as the potential of the drive electrode 16a increases, the central portion of the piezoelectric substance 16c in the width direction (nozzle row direction) is bent toward the inner side of the pressure chamber 15 (side approaching the nozzle plate 18), and the elastic film 23 is deformed to decrease the volume of the pressure chamber 15. In contrast, as the potential of the drive electrode 16a decreases (as approaching 0), the central portion of the piezoelectric substance 16c in the short length direction is bent toward the outer side of the pressure chamber 15 (side separating from the nozzle plate 18), and thus the elastic film 23 is deformed to increase the volume of the pressure chamber 15. As above, when the piezoelectric element 16 is driven, the volume of the pressure chamber 15 changes, and thus the pressure of ink which is inside the pressure chamber 15 changes in accordance therewith. Further, it is possible to eject ink droplets from the nozzles 17 by controlling the change in pressure of ink.

Subsequently, the electrical configuration of the printer 1 will be described.

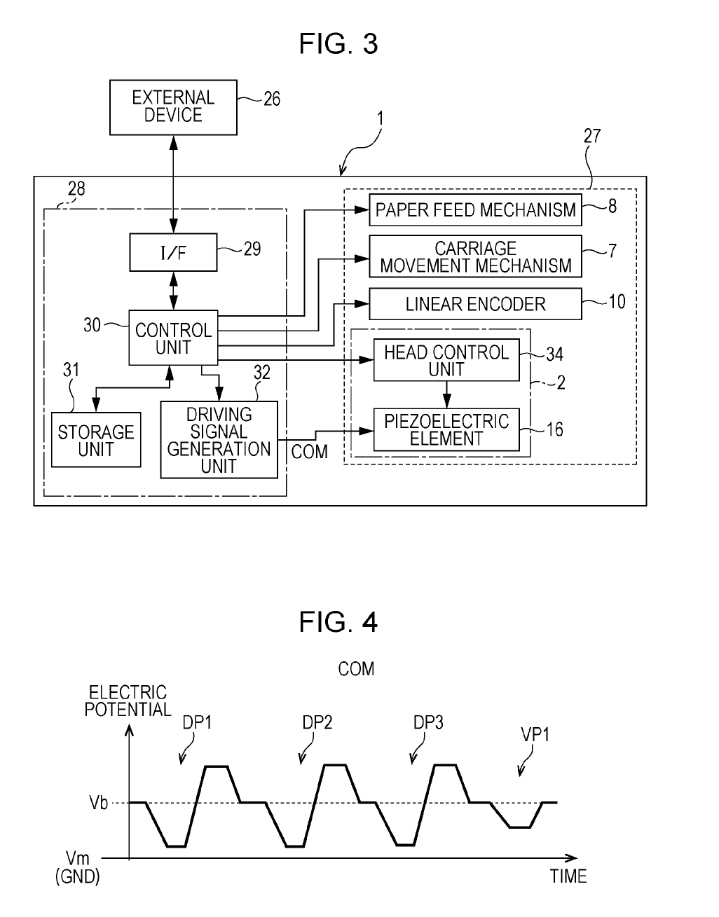

FIG. 3 is a block diagram illustrating the electrical configuration of the printer 1. An external device 26 is, for example, electronic equipment, such as a computer, a mobile phone, a mobile information terminal device, or a digital camera, which treat images. The external device 26 is communicably connected to the printer 1, and transmits print data based on an image to the printer 1 in order to print out the image or text on the recording medium, such as recording paper, in the printer 1.

The printer 1 according to the embodiment includes a printer controller 28 and a print engine 27. The printer controller 28 is one kind of a controller according to the invention, and is a control unit which controls each of the units of the printer. The printer controller 28 includes an interface (I/F) unit 29, the control unit 30, a storage unit 31, and a driving signal generation unit 32. The interface unit 29 transmits and receives the state data of the printer such that the external device 26 transmits print data or a print command to the printer 1 and that the external device 26 receives the state information of the printer 1. The control unit 30 is an arithmetic processing unit which controls the whole printer. The storage unit 31 is an element which stores the program of the control unit 30 or data used for various types of control, and includes a ROM, a RAM, and a NVRAM (non-volatile memory element). The control unit 30 controls each of the units according to a program which is stored in the storage unit 31.

FIG. 4 is a waveform chart illustrating an example of a driving signal COM which is generated by the driving signal generation unit 32.

The driving signal generation unit 32 is a portion which functions as a driving voltage waveform generation section, and generates an analog voltage signal based on waveform data related to the waveform of the driving signal. In addition, the driving signal generation unit 32 amplifies the voltage signal and generates the driving signal COM. The printer 1 according to the embodiment enables multi-gradation record in which dots having different sizes are formed on the recording paper 6. The embodiment is configured such that it is possible to perform the recording operation using four gradations of a large dot, a medium dot, a small dot, and non-ejection (minute vibration). Further, the driving signal generation unit 32 generates the driving signal COM which is configured to include, for example, a first ejection driving pulse DP1, a second ejection driving pulse DP2, a third ejection driving pulse DP3, and a vibration pulse VP1 (all of these are one kind of a driving voltage waveform), which causes the meniscus of the nozzle 17 to vibrate, as shown in FIG. 4. The driving signal COM is a driving signal which is used when ink is ejected to the recording medium (recording paper 6) and an image, text, or the like is recorded (printed). At least one of the driving pulses of the driving signal COM is selectively supplied to the piezoelectric element 16 when the recording head 2 moves at a constant speed in the recording area on the recording paper 6.

The ejection driving pulses DP1 to DP3 are driving pulses in which the driving voltage (potential difference from the lowest potential to the highest potential of the driving pulse) in order to eject ink from the nozzle 17, a waveform, or the like is determined. Further, in the embodiment, the size of the dot to be recorded on the recording medium changes based on the number of selections of each of the ejection driving pulses included in the driving signal COM. More specifically, when all of the three ejection driving pulses, that is, the ejection driving pulses DP1 to DP3 are selected and supplied to the piezoelectric element 16, ink is ejected from the nozzles 17 three times in a row. When the ink lands on the specific pixel area of the recording paper 6 which is the recording medium, large dots are formed. Similarly, when two ejection driving pulses, for example, the first ejection driving pulse DP1 and the third ejection driving pulse DP3 are selected from each of the ejection driving pulses and supplied to the piezoelectric element 16, ink is ejected from the nozzles 17 two times in a row, and thus medium dots are formed on the recording paper 6. In addition, one ejection driving pulse, for example, the second ejection driving pulse DP2 is selected from each of the ejection driving pulses and supplied to the piezoelectric element 16, ink is ejected from the nozzles 17 once, and thus small dots are formed on the recording paper 6. Meanwhile, the large, medium, and small sizes which indicate the sizes of dots are relative. The actual sizes of dots and the amount of liquid are determined based on the specification of the printer 1. In addition, the vibration pulse VP1 is a driving pulse which is set to a driving voltage or a waveform capable of causing meniscus to vibrate at a degree in which ink does not eject from the nozzles 17 in order to suppress the thickening of ink of the nozzles 17 during the recording operation.

The control unit 30 of the printer controller 28 functions as a timing pulse generation section which generates a timing pulse PTS from an encoder pulse EP output from the linear encoder 10. Further, the control unit 30 controls the transmission of the print data in synchronization with the timing pulse PTS or the generation of the driving signal by the driving signal generation unit 32. In addition, the control unit 30 generates a timing signal, such as a latch signal LAT, and outputs the timing signal to the head control unit 34 of the recording head 2 based on the timing pulse PTS. The head control unit 34 controls the supply of the ejection driving pulse or the vibration driving pulse, which is included in the driving signal COM, with regard to the piezoelectric element 16 of the recording head 2 based on the head control signal (the print data and the timing signal) from the printer controller 28. Further, the control unit 30 according to the embodiment corrects the ejection driving pulse DP based on a recording mode. The details will be described later.

Here, the printer 1 which includes the above configuration is configured to be capable of switching between two types of recording modes, that is, a single-pass mode (first mode) in which an image or the like is recorded in the recording area of the recording paper 6 by pass performed one time in the main scan direction and a multi-pass mode (second mode) in which an image is recorded in the recording area of the recording paper 6 by pass performed a plurality of times in the main scan direction in a recording process (one kind of a liquid ejection process) to form an image on the recording paper 6 in such a way that the recording head 2 scans the recording paper 6 and ink is ejected.

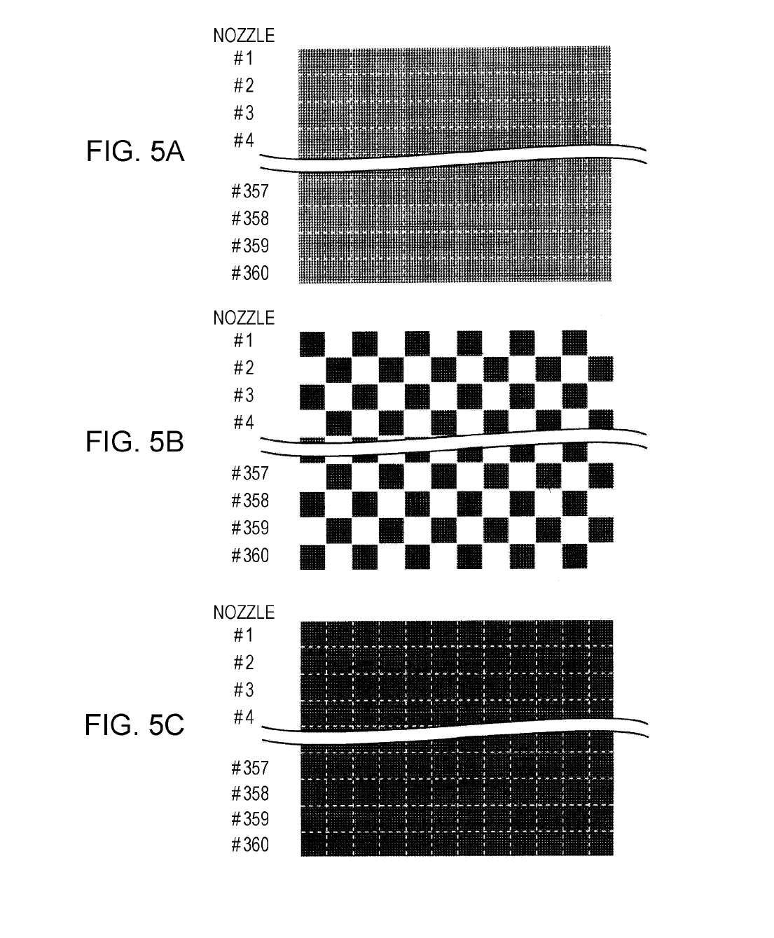

FIGS. 5A to 5C are schematic diagrams illustrating the recording of an image in each recording mode, FIG. 5A illustrates a case of the single-pass mode, and FIGS. 5B and 5C illustrate cases of the multi-pass mode, respectively. Meanwhile, the concentration of the pigment of the land ink is expressed by the shades of hatching in the drawings. In addition, in FIGS. 5A and 5B, portions which are surrounded by dashed lines express pixel areas and the dashed lines are not actually recorded.

In the single-pass mode, dot rows, which include a plurality of dots along the sub-scan direction which is a transport direction, are sequentially formed in the main scan direction, and a bundle (band) of raster lines (dot rows along the main scan direction) is recorded by pass performed one time. Further, in a transport operation which is performed between passes, the recording paper 6 is transported in the sub-scan direction by a distance corresponding to the total length of the nozzle row. Further, when the recording of the image and the transport operation are alternately repeated in each pass, the band is connected in the transport direction, and thus the image or the like is formed. In a case of FIG. 5A, a single band is constructed by 360 raster lines which are formed in the sub-scan direction at the same pitch as a nozzle pitch.

In contrast, the multi-pass mode is a mode in which an image is recorded on the recording paper 6 by pass performed a plurality of times in the main scan direction. In the embodiment, pixels which are included in the raster line are thinned out, and the raster line is recorded by pass performed a plurality of times. That is, for example, after dots are formed one after the other by first pass as shown in FIG. 5B, dots are formed by second pass such that gaps between the dots which are formed by the first pass are filled as shown in FIG. 5C, and thus the band is formed. During the period, sub-scan, in which the recording paper 6 is transported, is not performed. Such a recording method is called an overlapping method. When the band is recorded in this manner, the recording paper 6 is transported in the sub-scan direction by a distance corresponding to the total length of the nozzle row, with the result that the band is repeatedly recorded, and thus an image is formed, similarly to the single-pass mode.

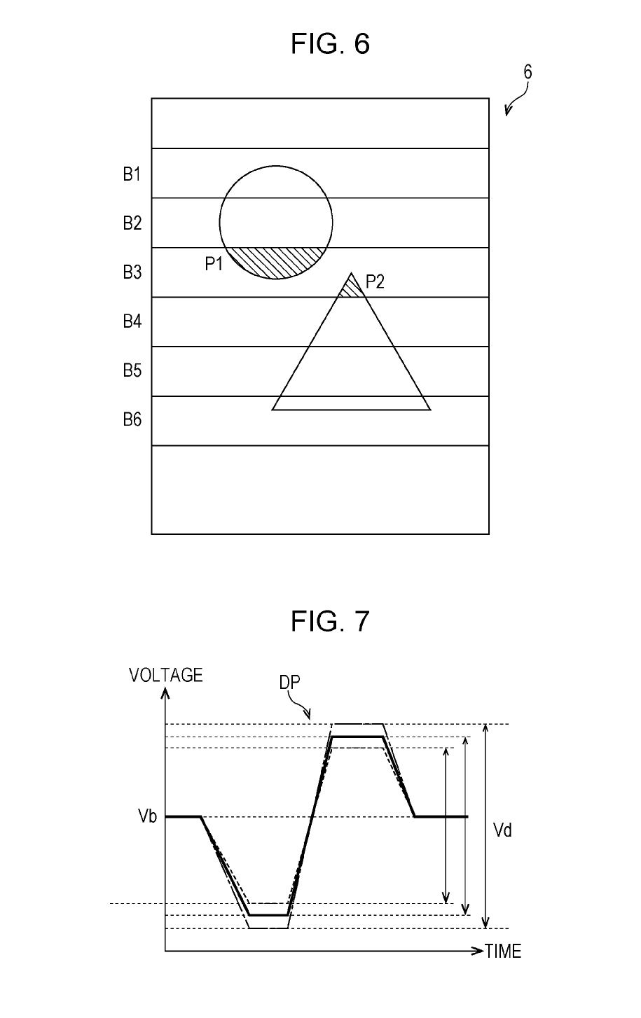

Meanwhile, for example, when images shown in FIG. 6 are recorded on the recording paper 6 in each of the recording modes, the recording area (pattern forming region) means an area in which images, letters or the like are recorded using dot arrays (landing patterns) formed by landing ink, and means parts in which a circle and a triangle are recorded in an example of FIG. 6. In addition, for example, when a third band B3 from the top is focused, the landing patterns, acquired when the band is recorded, mean the parts P1 and P2 which are expressed by hatching.

Here, when images are recorded on the recording paper 6 using permeation ink, there is a problem in that the concentrations of the images are different from each other if some kind of measures are not taken even though the same images are recorded in the case of the single-pass mode and the case of the multi-pass mode. More specifically, the concentration of an image which is recorded by the single-pass (refer to FIG. 5A) is lower than the concentration of an image which is recorded by the multi-pass (refer to FIG. 5B). That is, compared to the case in which recording is performed by the multi-pass, a larger amount of ink lands on the recording paper at a time (per unit time) in the case in which recording is performed by the single-pass, and thus ink does not easily dry. Therefore, it is conceivable that the pigment concentration of the surface of the recording paper 6 decreases because the pigment permeates into the recording paper during a period until ink dries.

The control unit 30 of the printer 1 according to the invention corrects the ejection driving pulse DP based on the recording mode, thereby performing control such that the concentrations of the images are made uniform regardless of the recording mode. More specifically, when a specific landing pattern is formed, control is performed such that the total amount of ink, which lands on the landing pattern forming region is relatively great in the case of the single-pass mode compared to the case of the multi-pass. In the embodiment, as shown in FIG. 7, correction is performed such that the driving voltage Vd of each of the ejection driving pulses DP1 to DP3 (potential difference from the lowest potential to the highest potential) of the driving signal COM used in the single-pass mode is higher than the driving voltage Vd of each of the ejection driving pulses DP1 to DP3 used in the multi-pass mode. Therefore, when a specific landing pattern is formed in the single-pass mode using the ejection driving pulse DP acquired after correction, the total amount of ink which lands on the landing pattern forming region is great in the case of the single-pass mode compared to the case of the multi-pass mode. Therefore, when recording is performed in the single-pass mode and even though the color material (pigment) permeates into the recording paper 6 during a period until the landing ink dries, the amount of the color material, which remains on the surface of the recording paper 6 after the color material dries, is made uniform to the same degree as in a case in which the same landing pattern is formed in the multi-pass mode. Therefore, it is possible to make the concentrations of the images (landing patterns) uniform regardless of the recording mode. That is, the concentrations of the images acquired when recording is performed in the single-pass mode are equal to those acquired when the recording is performed in the multi-pass mode shown in FIG. 5C.

Meanwhile, it is possible to cause the total amount of ink which lands on the landing pattern forming region to be less in the case of the multi-pass mode compared to the case of the single-pass. That is, a configuration may be made in which correction is performed such that the driving voltage Vd of each of the ejection driving pulses DP1 to DP3 of the driving signal COM used in the multi-pass mode is lower than the driving voltage Vd of each of the ejection driving pulses DP1 to DP3 used in the single-pass mode. In this case, when recording is performed in the multi-pass mode, the amount of color material which remains on the surface of the recording paper 6 acquired after the color material is dry is made uniform to the same degree as in the case in which the same landing pattern is formed in the single mode.

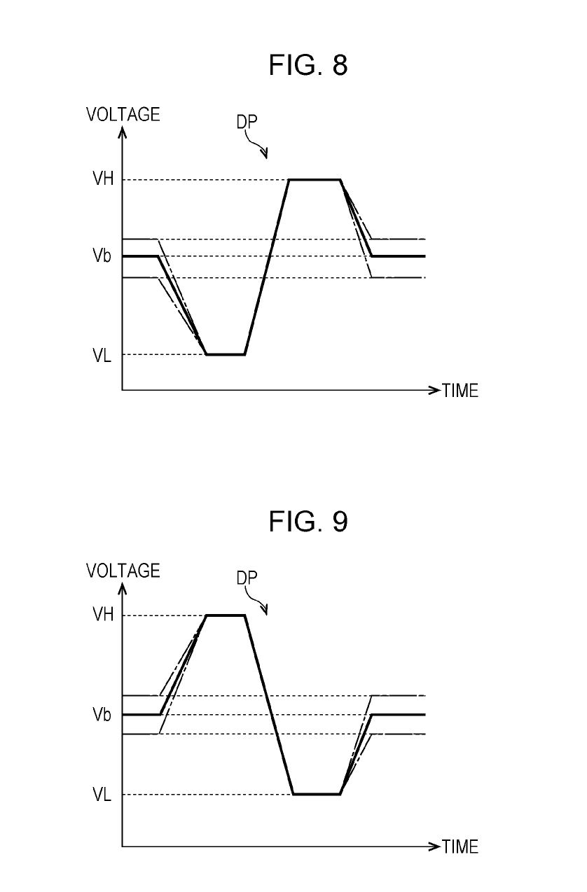

In addition, a method of correcting the ejection driving pulse DP is not limited to the configuration in which the driving voltage Vd is changed. For example, it is possible to use a configuration in which the reference potential Vb is changed based on a recording mode as shown in FIG. 8. More specifically, it is possible to perform correction such that the reference potential Vb of the ejection driving pulse DP (the potential which is the reference point of the change in the potential of the driving pulse) used in the single-pass mode is higher than the reference potential Vb of the ejection driving pulse DP used in the multi-pass mode. As described above, when the pressure chamber 15 is preliminarily extended before the ink is ejected, the pressure chamber 15 is more expanded by correcting the reference potential, and thus a drawn amount of meniscus increases. Accordingly, the amount of ink which is ejected from the nozzles 17 increases. Therefore, when a specific landing pattern is formed in the single-pass mode using the ejection driving pulse DP after the correction is performed, the total amount of ink which lands on the landing pattern forming region increases in the case of the single-pass mode compared to the case of the multi-pass. In addition, it is possible to perform the correction such that the reference potential Vb of the ejection driving pulse DP used in the multi-pass mode is lower than the reference potential Vb of the ejection driving pulse DP used in the single-pass mode. In this case, since the degree of expansion acquired when the pressure chamber 15 is expanded is small, the drawn amount of meniscus is small. Accordingly, the amount of ink which is ejected from the nozzles 17 is small. Therefore, with these configurations, it is possible to make the concentrations of the images (landing patterns) uniform regardless of the recording mode. In addition thereto, it is possible to adjust the amount of ink by changing the time width of the waveform component (component which reduces the volume of the pressure chamber to eject ink) of the ejection driving pulse DP related to the ejection of ink based on the recording mode.

Further, it is possible to use a configuration in which a dot formation ratio (droplet landing ratio) is changed without correcting the ejection driving pulse DP. More specifically, a table (dot formation ratio table), in which the dot formation ratio used when an image is formed is defined, is recorded in the storage unit 31 or the like for each recording pattern, and recording is performed using the dot formation ratio based on the recording pattern. Here, for example, when a specific recording area is configured to include vertical 10×horizontal 10 pixels (configuration unit of an image), the dot formation ratio indicates a proportion of dots formed in the recording area which includes the total of 100 pixels (a proportion of the dots in the recording area). That is, for example, when the dot formation ratio is set to 30%, 30 dots are formed in the recording area. Further, when the dot formation ratio is caused to be relatively high in the case of the single-pass mode compared to the case of the multi-pass, the total amount of ink which lands on the landing pattern forming region is great in the case of the single-pass mode compared to the case of the multi-pass. In addition, since the dot formation ratio is relatively low in the case of the multi-pass mode compared to the case of the single-pass mode, the total amount of ink which lands on the landing pattern forming region is small in the case of the multi-pass mode compared to the case of the single-pass mode. Therefore, with the above-described configuration, it is possible to uniformly align the concentration of images (landing patterns) regardless of the recording mode.

In addition, in each embodiment, the so-called deflection oscillation-type piezoelectric element 16 is exemplified. However, the invention is not limited thereto. For example, it is possible to apply the invention to a so-called vertical vibration-type piezoelectric element. In this case, the waveform of an exemplified each driving signal (driving pulse) is a waveform in which the direction of the change of the potential is reversed, that is, the up and down thereof are reversed, as shown in FIG. 9. In this configuration, when the reference potential Vb is corrected, the results thereof are reverse of the embodiment. That is, correction is performed such that the reference potential Vb of the ejection driving pulse DP which is used in the single-pass mode is lower than the reference potential Vb of the ejection driving pulse DP which is used in the multi-pass mode or such that the reference potential Vb of the ejection driving pulse DP which is used in the multi-pass mode is higher than the reference potential Vb of the ejection driving pulse DP which is used in the single-pass mode.

Further, if a liquid ejecting apparatus ejects ultra-permeation liquid to a landing target having permeation, the invention is not limited to the printer. Further, it is possible to apply the invention to various types of ink jet type recording apparatuses, such as a plotter, a facsimile device and a copy machine, and a liquid ejecting apparatus other than the recording apparatus.

What is claimed is:

1. A liquid ejecting apparatus comprising:
a liquid ejecting head that includes a plurality of nozzles, ejects a liquid from the nozzles toward an landing target when a pressure generator is driven, and forms an landing pattern by causing the liquid to land on the landing target;
a scan section that performs scan by relatively moving the liquid ejecting head with regard to the landing target; and
a controller that controls ejection of the liquid of the liquid ejecting head,
wherein the liquid is a ultra-permeation liquid which has a surface tension in a range of 25 mN/m or greater and 35 mN/m or less,
wherein the liquid ejecting apparatus is capable of switching between a first mode in which a specific landing pattern is formed on the landing target by scan performed once and a second mode in which the specific landing pattern is formed on the landing target by scan performed a plurality of times, and
wherein the controller performs control such that a total amount of liquid which lands on a region in which the specific landing pattern is formed is relatively great in a case of the first mode compared to a case of the second mode.

2. The liquid ejecting apparatus according to claim 1,
wherein the controller adjusts the total amount of liquid which lands on the region in which the specific landing pattern is formed by relatively changing a driving voltage of a driving waveform, which drives the pressure generator in the first mode, with regard to a driving voltage of a driving waveform which drives the pressure generator in the second mode.

3. The liquid ejecting apparatus according to claim 1,
wherein the controller adjusts the total amount of liquid which lands on the region in which the specific landing pattern is formed by relatively changing a reference potential of a driving waveform, which drives the pressure generator in the first mode, with regard to a reference potential of a driving waveform which drives the pressure generator in the second mode.

4. The liquid ejecting apparatus according to claim 1,
wherein the controller adjusts the total amount of liquid which lands on the region in which the specific landing pattern is formed by relatively changing a droplet landing ratio for the region, in which the specific landing pattern is formed in the first mode, with regard to a droplet landing ratio for a region in which the specific landing pattern is formed in the second mode.

5. A method of controlling a liquid ejecting apparatus which includes a liquid ejecting head that includes a plurality of nozzles, ejects a liquid from the nozzles toward an landing target when a pressure generator is driven, and forms an landing pattern by causing the liquid to land on the landing target; a scan section that performs scan by relatively moving the liquid ejecting head with regard to the landing target; and a controller that controls ejection of the liquid of the liquid ejecting head; the liquid being a ultra-permeation liquid which has a surface tension in a range of 25 mN/m or greater and 35 mN/m or less; and the liquid ejecting apparatus being capable of switching between a first mode in which a specific landing pattern is formed on the landing target by scan performed once and a second mode in which the specific landing pattern is formed on the landing target by scan performed a plurality of times, the method comprising:
performing control such that a total amount of liquid which lands on a region in which the specific landing pattern is formed is relatively greater in a case of the first mode compared to a case of the second mode.
